(19) United States
(12) Patent Application Publication
(10) Pub. No.: US 2006/0148563 A1
(43) Pub. Date: Jul. 6, 2006

(54) Gaming peripheral apparatus for a gaming computing device

(75) Inventor: Jin-Hsin Yang, Hsinchu Hsien (TW)

Correspondence Address: PILLSBURY WINTHROP SHAW PITTMAN, LLP, P.O. BOX 10500, MCLEAN, VA, 22102, US

(73) Assignee: PIXART IMAGING INC., Hsinchu Hsien (TW)

(21) Appl. No.: 11/181,810

(22) Filed: Jul. 15, 2005

(30) Foreign Application Priority Data
Jan. 4, 2005 (TW) 94100151

(51) Int. Cl. A63F 13/00

(52) U.S. Cl. 463/36; 463/37

(57) ABSTRACT

A gaming peripheral apparatus for a gaming computing device includes a passive marker and an interactive input device. The passive marker has a surface covered with a reflective layer for reflecting light invisible to human eyes. The interactive input device includes at least one light source, an image sensing module, a filter unit, and an interface module. Each light source emits light that is invisible to human eyes and that is to be reflected by the passive marker. The image sensing module generates image data corresponding to images that include the passive marker and that are sensed thereby. The filter unit is disposed in front of the image sensing module, and filters light visible to human eyes from the images sensed by the image sensing module. The interface module is coupled electrically to the image sensing module, and is adapted for transmitting the image data to the gaming computing device.

### CROSS-REFERENCE TO RELATED APPLICATION

This application claims priority of Taiwanese application no. 094100151, filed on Jan. 4, 2005.

### BACKGROUND OF THE INVENTION

1. Field of the Invention

The invention relates to a gaming peripheral apparatus for a gaming computing device, more particularly to a gaming peripheral apparatus that includes a reflective passive marker and an interactive input device emitting light invisible to human eyes.

2. Description of the Related Art

Video games, such as TV games and PC games, are very popular for entertainment and recreation. In general, PC games involve execution of computer software by a computing device, and operation of a computer input peripheral device, such as a keyboard, a computer mouse, a joystick, a game pad, etc., for game control. However, these computer input peripheral devices make many video games less realistic.

Interactive video games require interactive tools for game control. For example, a dancing pad game involves a dancing pad for flashing dancing instructions where the game player must step on, whereas a mock-shooting game requires a toy gun for shooting at virtual targets on a screen. In the case of the regular dancing pad game, only the dancing movements of the legs of the game player are relied upon for game control.

According to U.S. Patent Application Publication No. 20040063481, there are conventional video based pose determination devices in the prior art that are based on passive markers. The passive markers, which are usually made of light reflective materials or covered by light reflective materials, are illuminated with a bright light source such that the passive markers shine bright due to their reflective surfaces. Video cameras are then used to capture the pose (i.e., both object position and orientation in space) of the passive markers such that, when the passive markers are attached to a human body, human body movement can be determined based on the captured poses of the passive markers. However, to ensure proper functioning of the aforesaid conventional pose determination devices, a reasonably controlled lighting environment is required. In particular, a very dim surrounding lighting environment can affect movement of the game player. On the other hand, a very bright surrounding lighting environment can affect accurate determination of the poses of the passive markers.

To overcome the aforementioned drawback of the conventional video based pose determination devices, U.S. Patent Application Publication No. 20040063481 discloses an apparatus that comprises an input computing device, a game computing device, a screen device, and a marking device comprised of a lighting device. The lighting device is comprised of one or more light sources that emit light visible to video cameras but not necessarily visible to human eyes. The input computing device uses the light emitted from the lighting device to determine a pose of an object attached to the marking device, and passes the pose information to the game computing device. The game computing device then uses the pose of the object to determine and control the pose and the action of a virtual object in the game computing device or on the screen device.

Because the light sources are attached to the marking device, the light sources will be imaged as bright blobs in captured video images when turned on. The bright blobs are easier to detect and distinguish from a background as compared to visible light reflected from the passive markers of the conventional video based pose determination devices.

However, because the marking device includes the lighting device, there are numerous factors that have to be considered when designing the marking device. These factors, such as the location of the light sources on the marking device, whether or not the light sources and the power source of the lighting device can cause game player discomfort when the marking device is designed for wearing by the game player, etc., result in complexity during the design of the marking device.

### SUMMARY OF THE INVENTION

Therefore, the object of the present invention is to provide a gaming peripheral apparatus for a gaming computing device that includes a reflective passive marker and an interactive input device emitting light invisible to human eyes so as to overcome the aforesaid drawbacks of the prior art.

Accordingly, a gaming peripheral apparatus for a gaming computing device of this invention comprises a passive marker and an interactive input device.

The passive marker has a surface covered with a reflective layer for reflecting light that is invisible to human eyes.

The interactive input device includes at least one light source, an image sensing module, a filter unit, and an interface module. Each light source emits light that is invisible to human eyes and that is to be reflected by the passive marker. The image sensing module generates image data corresponding to images that include the passive marker and that are sensed thereby. The filter unit is disposed in front of the image sensing module, and filters light that is visible to human eyes from the images sensed by the image sensing module. The interface module is coupled electrically to the image sensing module, and is adapted for transmitting the image data to the gaming computing device.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of the preferred embodiment of a gaming peripheral apparatus for a gaming computing device according to the present invention; and

FIG. 2 is a system block diagram of the preferred embodiment.

### DETAILED DESCRIPTION OF THE PREFERRED EMBODIMENT

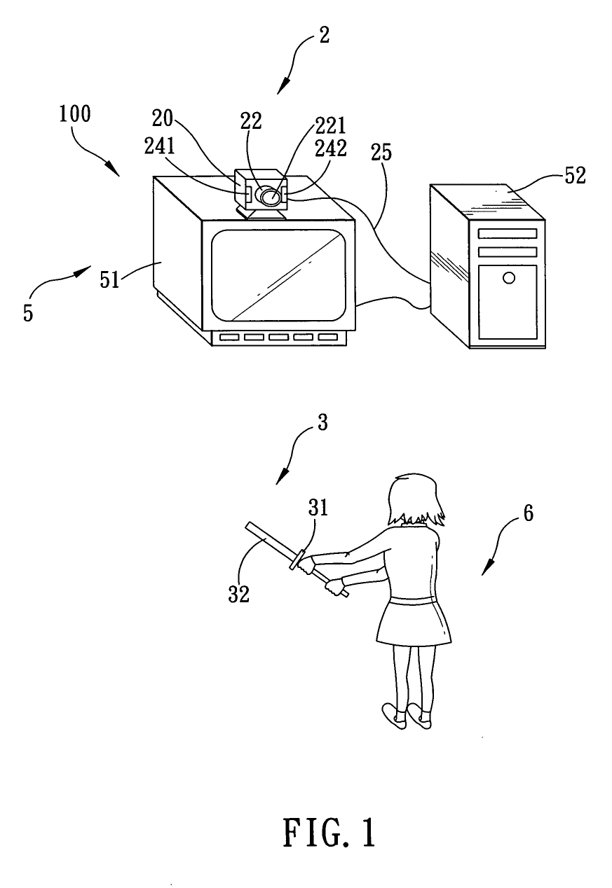

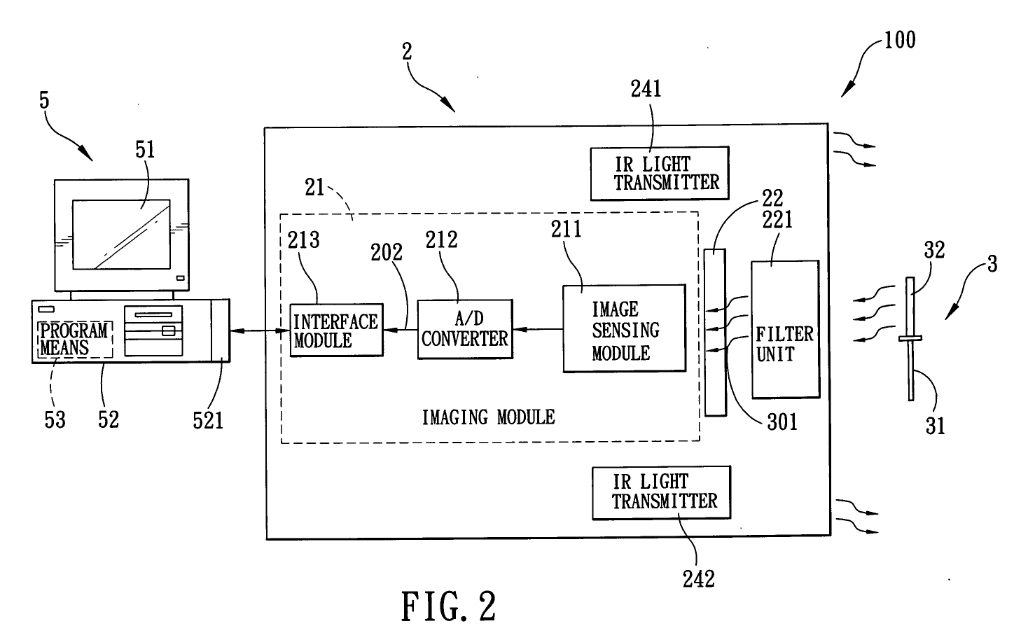

Referring to FIGS. 1 and 2, the preferred embodiment of a gaming peripheral apparatus 100 for a gaming computing device 5 includes a passive marker 3 and an interactive input device 2. In this embodiment, the gaming computing device 5 includes a personal computer that has a monitor 51 and a host device 52 with a transmission interface 521.

The passive marker 3 is adapted to be moved by a game player 6 when playing a video game, and may be in the shape of a ball, a bat, a toy sword, etc. The passive marker 3 has a surface 31 covered with a reflective layer 32 for reflecting light that is invisible to human eyes. In this embodiment, the reflective layer 32 includes a reflective cloth, which comprises a material that complies with industry standards, such as EN471, for reflecting light within the infrared spectrum.

The interactive input device 2 of the gaming peripheral apparatus 100 is adapted to be coupled to the host device 52 of the gaming computing device 5 through a cable 25, and is preferably placed on top of the monitor 51 of the gaming computing device 5 for capturing images that include the passive member 3. The interactive input device 2 includes a housing 20, a lens 22 mounted on a front side of the housing 20, a filter unit 221 mounted in front of the lens 22, a pair of light sources 241, 242 disposed on opposite sides of the lens 22, and an imaging module 21 disposed in the housing

Each of the light sources 241, 242 is an infrared (IR) light transmitter, and emits infrared light that is invisible to human eyes and that is to be reflected by the passive marker 3. While there are only two light sources 241, 242, the actual number of the light sources may be increased to enhance the luminance and homogeneousness of the emitted infrared light.

The filter unit 221 is mounted removably in front of the lens 22, and includes an optical filter, such as an IR filter that is capable of filtering light visible to human eyes (for instance, light with wavelength less than 800 nm). In other words, the filter unit 221 ensures that infrared light 301 (for instance, light with wavelength larger than 800 nm) can pass through the lens 22. In other embodiments, the filter unit 221 may be integrated into a glass layer of the lens 22.

The imaging module 21 is disposed rearwardly of the lens 22, and includes an image sensing module 211, an interface module 213, and an analog-to-digital (A/D) converter 212 coupled between the image sensing module 211 and the interface module 213. The image sensing module 211 receives the filtered infrared light 301, and cooperates with the A/D converter 212 to generate digital image data 202 corresponding to images that include the passive marker 3 and that are sensed by the image sensing module 211. The image sensing module 211 preferably includes one of a charge-coupled device (CCD) and a complementary metal oxide semiconductor (CMOS) sensor. The interface module 213 is adapted for transmitting the digital image data 202 to the transmission interface 521 of the host device 52 of the gaming computing device 5 through the cable 25. In this embodiment, each of the interface module 213 and the transmission interface 521 of the host device 52 includes a universal serial bus (USB) interface. In other embodiments, each of the interface module 213 and the transmission interface 521 of the host device 52 includes a universal asynchronous receiver/transmitter (UART) interface.

Preferably, the imaging module 21 is implemented as a single integrated circuit chip. That is, the image sensing module 211, the A/D converter 212, and the interface module 213 are integrated into a single integrated circuit chip. In other embodiments, the image sensing module 211 and the A/D converter 212 are integrated into a single integrated circuit chip that is connected to an external interface module 213.

The gaming peripheral apparatus 100 further comprises program means 53 adapted to be executed by the host device 52 of the gaming computing device 5 for enabling the gaming computing device 5 to determine pose of the passive marker 3 from the digital image data 202 received from the interactive input device 2.

It should be noted that, in this embodiment, since only bright areas in the captured images that are attributed to reflected light from the passive member 3 are required to be detected, the resolution of the image sensing module 211 need not be very high. A resolution of 1 million pixels was found to be sufficient for the gaming peripheral apparatus 100 of this invention. However, in order to detect movement of the passive member 3, the frame rate is required to be at least 200 frames per second.

While this invention has been exemplified for use with a gaming computing device, it is apparent to those skilled in the art that the apparatus 100 of this invention may be applied to other devices, such as educational computing devices, as well.

In sum, the apparatus 100 of this invention does not require integration of the light sources 241, 242 with the passive marker 3 such that the passive marker 3 may be designed with relative ease. In addition, since the light sources 241, 242 in this invention emit infrared light, and since the filter unit 221 removes light that is visible to human eyes from the images sensed by the image sensing module 211, the effect of a very bright surrounding lighting environment upon the determination of the pose of the passive marker 3 can be reduced to a minimum.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A gaming peripheral apparatus for a gaming computing device, comprising:
a passive marker having a surface covered with a reflective layer for reflecting light that is invisible to human eyes; and
an interactive input device including
at least one light source for emitting light that is invisible to human eyes and that is to be reflected by said passive marker,
an image sensing module for generating image data corresponding to images that include said passive marker and that are sensed thereby,
a filter unit disposed in front of said image sensing module for filtering light that is visible to human eyes from the images sensed by said image sensing module, and
an interface module coupled electrically to said image sensing module and adapted for transmitting the image data to the gaming computing device.

2. The gaming peripheral apparatus as claimed in claim 1, further comprising program means adapted to be executed by the gaming computing device for enabling the gaming computing device to determine pose of said passive marker from the image data received from said interactive input device.

3. The gaming peripheral apparatus as claimed in claim 1, wherein said light source is an infrared light source, and said reflective layer reflects infrared light.

4. The gaming peripheral apparatus as claimed in claim 1, wherein said filter unit is mounted removably in front of said image sensing module.

5. The gaming peripheral apparatus as claimed in claim 1, wherein said image sensing module includes a charge-coupled device (CCD).

6. The gaming peripheral apparatus as claimed in claim 1, wherein said image sensing module includes a complementary metal oxide semiconductor (CMOS) sensor.

7. The gaming peripheral apparatus as claimed in claim 1, wherein said interactive input device further includes an analog-to-digital converter coupled between said image sensing module and said interface module.

8. The gaming peripheral apparatus as claimed in claim 1, wherein said interface module includes a universal asynchronous receiver/transmitter (UART) interface.

9. The gaming peripheral apparatus as claimed in claim 1, wherein said interface module includes a universal serial bus (USB) interface.

10. The gaming peripheral apparatus as claimed in claim 1, wherein said interface module and said image sensing module are integrated into a single integrated circuit chip.

11. The gaming peripheral apparatus as claimed in claim 7, wherein said analog-to-digital converter, said interface module and said image sensing module are integrated into a single integrated circuit chip.
